(19) United States
(12) Patent Application Publication
(10) Pub. No.: US 2018/0306939 A1
(43) Pub. Date: Oct. 25, 2018

(54) Correcting Biases In Microseismic-Event Data

(71) Applicant: Landmark Graphics Corporation, Houston, TX (US)

(72) Inventors: Thomas Bartholomew O'Toole, Maidenhead, Berkshire (GB); Yevgeniy Zagayevskiy, Didcot, Oxfordshire (GB); Raquel Morag Velasco, Houston, TX (US); Ashwani Dev, Katy, TX (US)

(21) Appl. No.: 15/560,001

(22) PCT Filed: Oct. 20, 2016
(86) PCT No.: PCT/US2016/057922

§ 371 Date: Sep. 20, 2017

(51) Int. Cl. G01V 1/36; G01V 1/28; G01V 1/34

(52) U.S. Cl. CPC G01V 1/364; G01V 1/345; G01V 1/288

(57) ABSTRACT

Microseismic-event data can be corrected (e.g., to reduce or eliminate bias). For example, a first distribution of microseismic events that occurred in a first area of a subterranean formation can be determined. The first distribution can be used as a reference distribution. A second distribution of microseismic events that occurred in a second area of the subterranean formation can also be determined. The second area of the subterranean formation can be farther from an observation well than the first area. The second distribution can be corrected by including, in the second distribution, microseismic events that have characteristics tailored for reducing a difference between the second distribution and the first distribution.

### TECHNICAL FIELD

The present disclosure relates generally to devices used with wells. More specifically, but not by way of limitation, this disclosure relates to correcting biases in microseismic-event data.

### BACKGROUND

A well system (e.g., an oil or gas well system) can include a wellbore drilled through a subterranean formation. The wellbore can include perforations. Fluid can be injected through the perforations to create fractures in the subterranean formation in a process referred to as hydraulic fracturing. The fractures can enable hydrocarbons to flow from the subterranean formation into the wellbore, from which the hydrocarbons can be extracted.

### BRIEF DESCRIPTION OF THE DRAWINGS

FIG. 1 is a cross-sectional side view of an example of a well system that includes a computing device for correcting biases in microseismic-event data according to some aspects.

FIG. 2 is a block diagram of an example of the computing device of FIG. 1 according to some aspects.

FIG. 3 is a series of graphs having differing numbers of microseismic events according to some aspects.

FIG. 4 is a flow chart showing an example of a process for correcting biases in microseismic-event data according to some aspects.

FIG. 5 is a graph that includes an example of a criterion according to some aspects.

FIG. 6 is a graph of an example of groups of microseismic events according to some aspects.

FIG. 7 is a graph of an example of distributions of microseismic events according to some aspects.

FIG. 8 is a series of graphs comparing an ideal arrangement of microseismic events to an arrangement of microseismic events generated using the process of FIG. 4 according to some aspects.

### DETAILED DESCRIPTION

Certain aspects and features of the present disclosure relate to using microseismic events (e.g., resulting from the creation of a fracture in a subterranean formation) that occurred in a first part of a subterranean formation to define a reference distribution. The reference distribution can include a spatial distribution of the microseismic events that occurred in the first part of the subterranean formation. The reference distribution can be compared to other distributions of microseismic events that occurred in other parts of the subterranean formation that are farther from an observation well (e.g., a wellbore that is proximate to the microseismic events and has sensors for detecting the microseismic events) than the first part. The other distributions can be corrected, as needed, by including pseudo-microseismic events into the distributions until they substantially conform to the reference distribution. The corrected distributions of microseismic events can be used to provide a well operator with a realistic estimate of the distribution of microseismic events that occurred in the subterranean formation. This estimated distribution can be more accurate and realistic than other estimate distributions generated using other approaches.

More specifically, microseismic events can generate elastic waves that travel through the subterranean formation. Microseismic events occurring closer to the observation well may be detected at the observation well, because their corresponding elastic waves undergo less attenuation and geometric spreading before they reach the observation well. And microseismic events occurring farther from the observation well may not be detected at the observation well, because their corresponding elastic waves undergo more attenuation and geometric spreading before they reach the observation well. That some microseismic events may be detected, and others not detected, based on their location with respect to the observation well can be referred to as bias (or observation bias). The bias can lead to more microseismic events being detected in parts of the subterranean formation that are closer to the observation well than parts of the subterranean formation that are farther from observation well. The bias can result in an estimated distribution that is inaccurate, or can otherwise negatively influence estimates of fracture parameters (e.g., fracture height, length, symmetry, or geometry).

One approach for correcting for this bias can include filtering microseismic events by their magnitudes so that microseismic events with magnitudes above a threshold are only used in the estimated distribution. By filtering out the lower-magnitude microseismic events, a more homogenous estimated-distribution can be achieved. For example, after performing the filtering process, the number of microseismic events closer to the observation well (in the estimated distribution) may not be significantly different from the number of microseismic events that are farther from the observation well (in the estimated distribution). But this filtering process may also lead to an estimated distribution that is less accurate because only a small fraction of the microseismic events that were detected is actually used in the estimation. Further, the filtering process can lead to wasted time and money spent detecting, recording, and processing lower-magnitude microseismic events that ultimately do not inform the estimated distribution.

Some examples of the present disclosure can overcome one or more of the abovementioned issues by “filling in” some or all of the undetected microseismic events during the correction process (e.g., while correcting the other distributions of microseismic events to conform to the reference distribution), rather than filtering out lower-magnitude microseismic events. This procedure can alleviate the bias and result in a more accurate and realistic estimate of the distribution of microseismic events in the subterranean formation. In some examples, this estimated distribution can then be used with other tools and processes that rely on a distribution of microseismic events (e.g., tools for determining fracture geometry, stimulated reservoir volume, or both of these), thereby enhancing the accuracy of those tools and processes.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

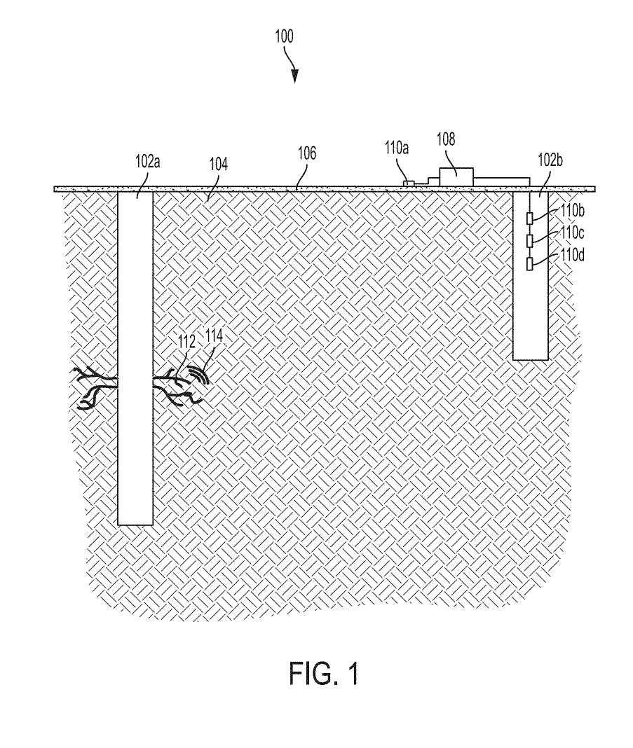

FIG. 1 is a cross-sectional side view of an example of a well system 100 that includes a computing device 108 for correcting biases in microseismic-event data according to some aspects. The well system 100 can include wellbores 102a-b extending through various earth strata that form a subterranean formation 104. The wellbores 102a-b can be vertical, deviated, horizontal, or any combination of these.

A well operator may wish to obtain hydrocarbons from the subterranean formation 104. To obtain the hydrocarbons, the well operator can perform hydraulic fracturing by injecting fluid at high pressure into the subterranean formation 104. The high pressure of the fluid can cause stresses on the rock in the subterranean formation 104 to change, causing the rock to slip or shear along a preexisting zone of weakness (e.g., a fault) and/or create a new fracture 112 along which slip can also occur. Such a slip or shear can be a microseismic event. The microseismic event can generate elastic waves 114 (e.g., an acoustic wave or shear wave) that propagate through the subterranean formation 104. In some examples, the fracture 112 can enable hydrocarbons to flow from the subterranean formation 104 into the wellbore 102a, from which the hydrocarbons can be extracted.

The elastic waves 114 can be detected by one or more sensors 110a-d (e.g., a microphone, accelerometer, geophone, or any combination of these). In some examples, at least one of the sensors 110a-d can be positioned at a surface 106 of the wellbore 102a, as shown by sensor 110a located at the surface 106. Additionally or alternatively, at least one of the sensors 110a-d can be positioned in a nearby wellbore 102b, which can be referred to as an observation well. For example, sensors 110b-d can be located in the wellbore 102b, which can be a certain distance from the wellbore 102a. The distance between the wellbores 102a-b can vary, but in some examples the wellbore 102b can be a wellbore that is closest among multiple wellbores to the wellbore 102a. Additionally or alternatively, at least one of the sensors 110a-d can be positioned in wellbore 102a itself.

The sensors 110a-d can be communicatively coupled to the computing device 108 via a wired or wireless link. The computing device 108 can receive sensor data from the sensors 110a-d. The computing device 108 can determine, based on the sensor data, microseismic-event data associated with one or more fractures in the subterranean formation 104.

Although the computing device 108 is depicted in FIG. 1 within the well system 100, in other examples, the computing device 108 can be positioned offsite for analyzing data that was previously obtained from the well system 100.

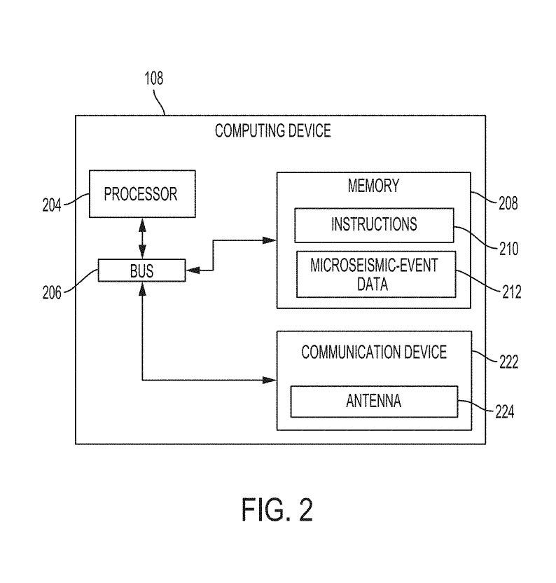

FIG. 2 is a block diagram of an example of the computing device 108 of FIG. 1 according to some aspects. The computing device 108 can include a processor 204, a memory 208, a bus 206, and a communication device 222. In some examples, some or all of the components shown in FIG. 2 can be integrated into a single structure, such as a single housing. In other examples, some or all of the components shown in FIG. 2 can be distributed (e.g., in separate housings) and in electrical communication with each other.

The processor 204 can execute one or more operations for correcting biases in microseismic-event data, such as microseismic-event data 212. The processor 204 can execute instructions 210 stored in the memory 208 to perform the operations. The processor 204 can include one processing device or multiple processing devices. Non-limiting examples of the processor 204 include a Field-Programmable Gate Array (“FPGA”), an application-specific integrated circuit (“ASIC”), a microprocessor, etc.

The processor 204 can be communicatively coupled to the memory 208 via the bus 206. The non-volatile memory 208 may include any type of memory device that retains stored information when powered off. Non-limiting examples of the memory 208 include electrically erasable and programmable read-only memory (“EEPROM”), flash memory, or any other type of non-volatile memory. In some examples, at least some of the memory 208 can include a medium from which the processor 204 can read instructions 210. A computer-readable medium can include electronic, optical, magnetic, or other storage devices capable of providing the processor 204 with computer-readable instructions or other program code. Non-limiting examples of a computer-readable medium include (but are not limited to) magnetic disk(s), memory chip(s), read-only memory (ROM), random-access memory (“RAM”), an ASIC, a configured processor, optical storage, or any other medium from which a computer processor can read instructions 210. The instructions 210 can include processor-specific instructions generated by a compiler or an interpreter from code written in any suitable computer-programming language, including, for example, C, C++, C#, etc.

The communication device 222 can be implemented using hardware, software, or both. The communication device 222 can receive communications from, and transmit communications to, a sensor (e.g., sensors 110a-d of FIG. 1). The communication device 222 can include a wired or wireless interface for communicating with the sensor. For example, the communication device 222 can include an antenna 224 for wirelessly communicating with the sensor. In some examples, the communication device 222 can include hardware or software configured to allow the communication device 222 to receive signals from the sensor and amplify, filter, modulate, de-modulate, frequency shift, and otherwise modify the signals. The communication device 222 can transmit the modified signals to the processor 204 for further processing.

The computing device 108 can include the microseismic-event data 212. The computing device 108 can perform one or more operations for correcting bias in the microseismic-event data 212.

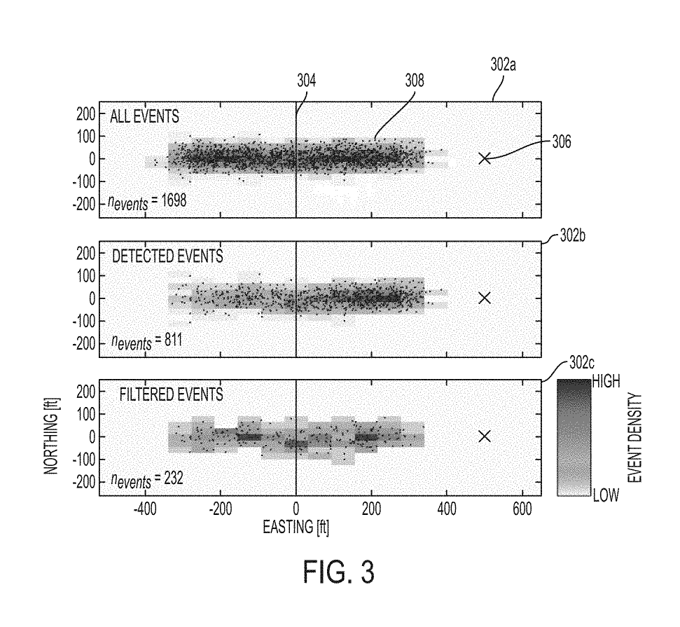

In some examples, the computing device 108 can filter the microseismic-event data 212 by magnitude to reduce the number of small-magnitude microseismic events in the output dataset. For example, turning to FIG. 3, graphs 302a-c show microseismic events from a synthetic data set generated for illustrative purposes. Each point in the graphs 302a-c can represent a microseismic event. Each shaded box in the graphs can indicate a density of microseismic events within that area. The points are distributed proximate to lines, such as line 304, which represent horizontal wellbores into which hydraulic fluid is pumped to create the microseismic events. The horizontal wellbores can extend from north to south and the microseismic events can be spread from east to west. The graphs 302a-c also include X symbols, such as X symbol 306, that represent observation wells (e.g., for detecting the microseismic events), which can extend in a direction into the page. Graph 302a can show all of the microseismic events 308 in the synthetic data set. This can represent all of the microseismic events that actually occurred in a subterranean formation. Graph 302b can show a subset of the microseismic events shown in graph 302a. This can represent the microseismic events that were actually detected by sensors in the observation well. Graph 302c can show a subset of the microseismic events from graph 302b. This can represent the microseismic events that are available for use after filtering the detected microseismic events by magnitude. As shown, the number of microseismic events available for use, after the filtering process, is substantially fewer than the number of microseismic events that actually occurred in the subterranean formation (e.g., as shown in graph 302a) or were detected at the observation well (e.g., as shown in graph 302b). The filtering process may lead to inaccurate results and wasted time and money spent detecting, recording, and processing microseismic events that are not actually used in subsequent analysis.

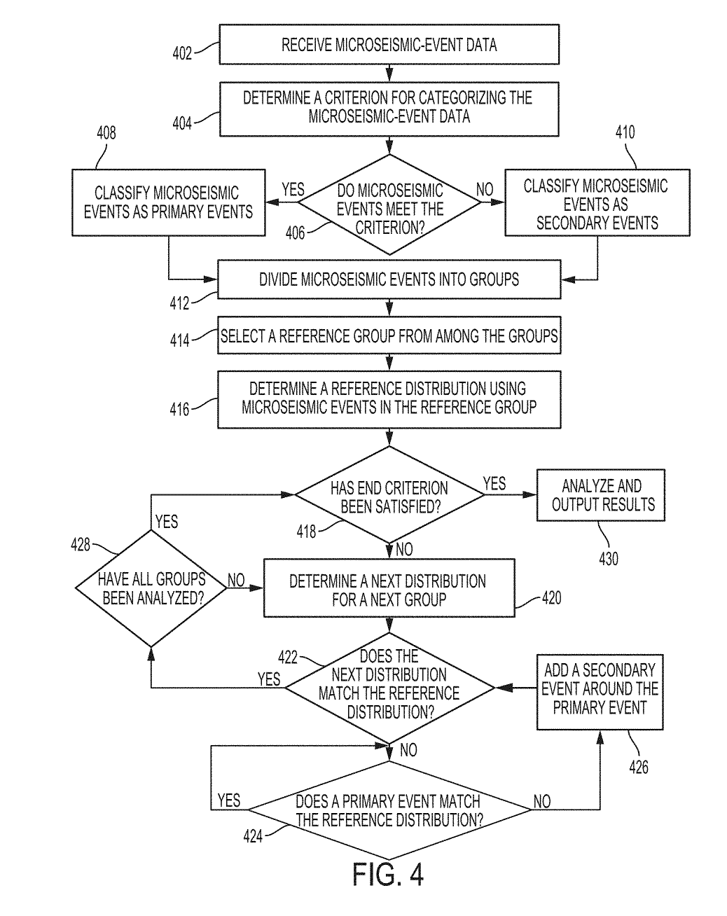

Some examples of the present disclosure can overcome one or more of the abovementioned issues by implementing the process shown in FIG. 4. Some examples can include more, fewer, or different steps than the steps depicted in FIG. 4. Also, some examples can implement the steps of the process in a different order. For clarity, the steps of FIG. 4 described below are discussed with reference to the components of FIG. 2, but other implementations are possible.

In block 402, the computing device 108 receives microseismic-event data 212. The microseismic-event data 212 can include information about a microseismic event. The information can include a coordinate (e.g., a three-dimensional coordinate having X, Y, and Z values) that represents a physical location in real space in which the microseismic event occurred. For example, the information can include a coordinate that indicates a physical location within a subterranean formation in which the microseismic event occurred. The information can additionally or alternatively include a magnitude, frequency, waveform, duration, or any combination of these for an elastic wave generated by the microseismic event. The information can additionally or alternatively include a time at which the microseismic event occurred, or moment tensor associated with the microseismic event. In some examples, the microseismic-event data can include information about multiple microseismic events.

In some examples, the computing device 108 can receive the microseismic-event data 212 from one or more sensors, such as sensors 110a-d of FIG. 1. For example, the computing device 108 can receive sensor signals associated with microseismic events from the sensors. The computing device 108 can determine the microseismic-event data 212 based on the sensors signals. For example, the computing device 108 can extract the microseismic-event data 212 from the sensor signals, or otherwise use the sensor signals to generate the microseismic-event data 212.

Additionally or alternatively, the computing device 108 can receive the microseismic-event data 212 as user input via a keyboard, mouse, touchscreen, or other input device. In some examples, the computing device 108 can additionally or alternatively obtain the microseismic-event data 212 from a database (e.g., stored in memory 208 or accessed via a network, such as the Internet).

In block 404, the computing device 108 determines a criterion for categorizing the microseismic-event data 212 into groups. Examples of the criterion can include a magnitude threshold, a frequency threshold, a duration threshold, a moment-tensor threshold, or any combination of these. In some examples, the computing device 108 can receive the criterion as user input via a keyboard, mouse, touchscreen, or other input device. In other examples, the computing device 108 can determine the criterion based on real data associated with microseismic events or synthetic data associated with microseismic events.

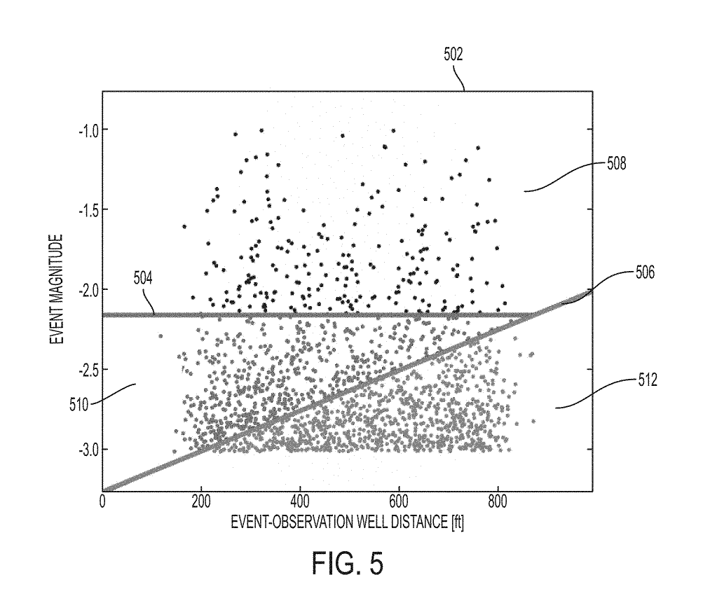

FIG. 5 shows a graph 502 that includes an example of a criterion according to some aspects. Each point on the graph 502 can represent a microseismic event (e.g., obtained from a synthetic data set). The X-axis of the graph 502 can indicate a distance between the microseismic event and an observation well (e.g., in which sensors are placed for detecting the microseismic event). The Y-axis can indicate a magnitude of the microseismic event. The line 504 can represent a threshold that is the criterion.

In one example, the computing device 108 can analyze the points shown in FIG. 5 to determine a minimum magnitude for which the microseismic events can be detected at an observation well, regardless of where the microseismic events occur within an area of interest relative to the observation well. This minimum magnitude (e.g., −2.1) can be represented by line 504. The computing device 108 can use the minimum magnitude as the criterion.

In some examples, the computing device 108 can categorize points above line 504 (e.g., in section 508 of the graph 502) into one group of points. As discussed above, these points can represent microseismic events that have large enough magnitudes that they can be detected at any point within an area of interest relative to the observation well. The computing device 108 can categorize points below line 504 and above the line 506 (e.g., in section 510 of the graph 502) into another group of points. These points may represent microseismic events that can be detected only when the microseismic events occur close enough to the observation well within the area of interest. The points below the line 506 (e.g., in section 512 of the graph 502) can represent microseismic events that are undetected (e.g., microseismic events that have magnitudes that are too low to be detected at the observation well, regardless of where they occur within the area of interest).

Referring back to FIG. 4, in block 406, the computing device 108 determines if a microseismic event in the microseismic-event data 212 meets the criterion. For example, the computing device 108 can determine if a characteristic of the microseismic event satisfies a condition. In one example, the computing device 108 can determine if the magnitude of the microseismic event meets or exceeds a magnitude threshold. As another example, the computing device 108 can determine if the microseismic event has a particular moment-tensor characteristic. If the microseismic event meets the criterion, the process can proceed to block 408 where the computing device 108 classifies the microseismic event as a primary event (e.g., a high magnitude event). Otherwise, the process can proceed to block 410 where the computing device 108 classifies the microseismic event as a secondary event (e.g., a low magnitude event). The computing device 108 can repeat this process for some or all of the microseismic events in the microseismic-event data 212.

In some examples, the computing device 108 can classify a microseismic event into a particular category based on multiple criteria. For example, the computing device 108 can determine if a first characteristic (e.g., magnitude) of the microseismic event is greater than or equal to a first threshold, and a second characteristic (e.g., origin time) of the microseismic event is less than or equal to another threshold. If so, the computing device 108 can classify the microseismic event as a primary event. Otherwise, the computing device 108 can classify the microseismic event as a secondary event. The computing device 108 can classify microseismic events into any number and combination of categories (e.g., types of events) based on any number and combination of criteria.

In block 412, the computing device 108 divides the microseismic events in the microseismic-event data 212 into groups. In some examples, the computing device 108 can divide the microseismic events into the groups based on the locations of the microseismic events in the subterranean formation (e.g., relative to an observation well).

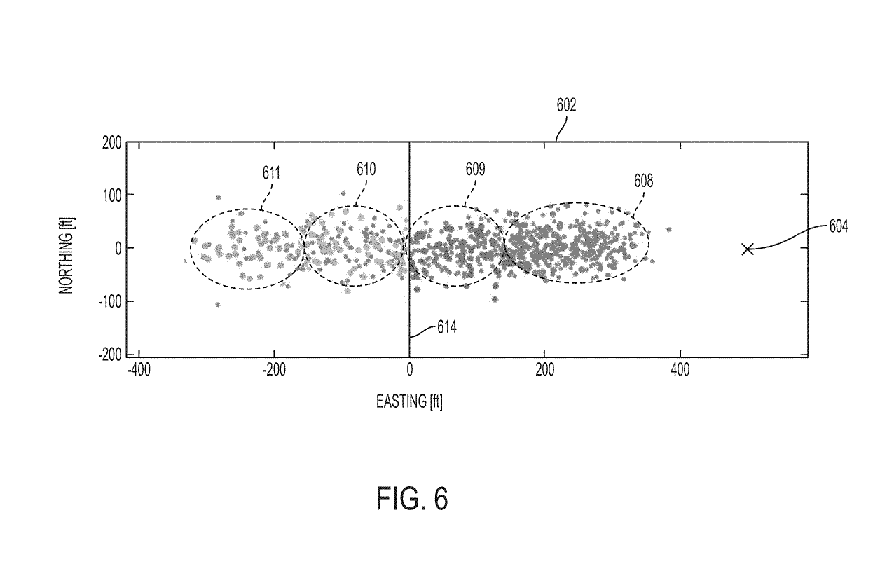

For example, FIG. 6 shows a graph 602 of points representing microseismic events. The points surround line 614, which represents a horizontal wellbore into which hydraulic fluid is pumped to create the microseismic events. The graph 602 also includes an X symbol 604 representing an observation well, which can extend in a direction into the page. The microseismic events are at varying distances from the observation well. The computing device 108 can divide the microseismic events into any number and combination of groups, such as groups 608-611, based on their distances to the observation well. For example, the computing device 108 can assign the microseismic events that occurred within a first distance range (e.g., between zero feet and 200 feet) from the observation well together into group 608. The computing device 108 can assign the microseismic events that occurred within a second distance range (e.g., between 201 feet and 400 feet) from the observation well together into group 609. The computing device 108 can assign the microseismic events that occurred within a third distance range (e.g., between 401 feet and 600 feet) from the observation well together into group 610. The computing device 108 can assign the microseismic events that occurred within a fourth distance range (e.g., between 601 feet and 800 feet) from the observation well together into group 611. And so on. Although each group covers an equal distance range (e.g., 200 feet) in this example, in other examples, the groups can cover any number and combination of distances.

In some examples, the computing device 108 can divide the microseismic events into groups according to other criteria. For example, the computing device 108 can divide the microseismic events based on a parameter that changes (e.g., a parameter for which the value changes for each group). This can result in at least two of the groups having different sizes from one another.

Referring back to FIG. 4, in block 414, the computing device 108 selects a reference group from among the groups. For example, the computing device 108 can select the closest group to the observation well as the reference group. For example, the computing device 108 can select group 608 of FIG. 6 as the reference group.

Selecting the closest group to the observation well as the reference group can lead to more accurate results. For example, elastic waves generated by microseismic events can attenuate or otherwise become distorted as they travel through the subterranean formation. The farther the elastic waves travel before reaching the sensors in the observation well, the more attenuated the elastic waves can become, making the elastic waves harder to detect. Also, noise from various other sources can be detected along with the elastic waves, and can obscure the elastic waves. These factors can lead to smaller-magnitude microseismic events being underrepresented in groups that are located farther from the observation well, because these smaller-magnitude microseismic events are less like to be detected or more likely to be discarded as noise. Likewise, these factors can lead to smaller-magnitude microseismic events being more adequately represented in groups that are located closer to the observation well, because these smaller-magnitude microseismic events are more likely to be detected and less likely to be discarded as noise. Thus, the group closest to the observation well can be the most accurate group to use as the reference group.

In block 416, the computing device 108 determines a reference distribution using the microseismic events in the reference group. A reference distribution can represent or express a spatial relationship between primary events and secondary events in a particular group. The reference distribution may characterize the density of secondary events around primary events. Thus, the reference distribution can represent a spatial relationship between the primary events and the secondary events in the reference group.

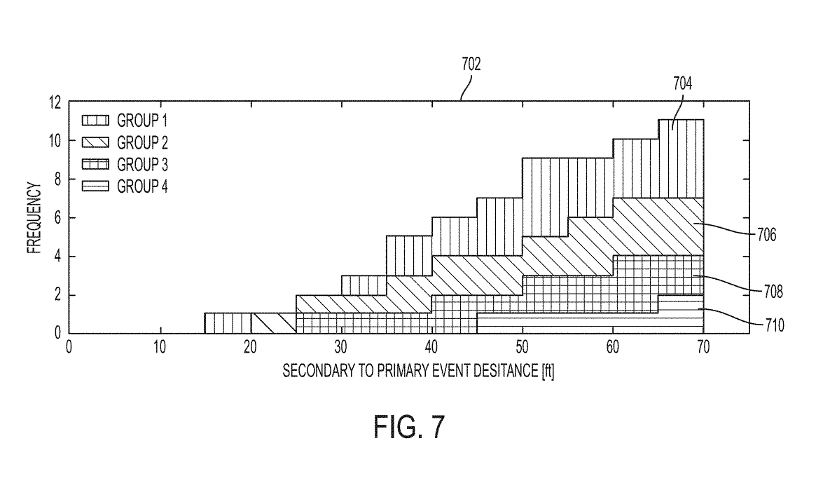

FIG. 7 is a graph 702 of an example of distributions of microseismic events according to some aspects. The X-axis of the graph 702 indicates a distance between a primary event and a secondary event occurring in a particular group. The Y-axis indicates the average number of times for which primary events and secondary events are at a certain distance from one another in the particular group. The graph 702 includes an example of a reference distribution 704. The reference distribution 704 indicates that there is, on average, one secondary event within 20 feet of a primary event, six secondary events between 40 and 45 feet of a primary event, 11 secondary events between 65 and 70 feet from a primary event, etc.

In some examples, the computing device 108 can determine the reference distribution 704 based on distances between the primary events and the secondary events in the reference group. For example, the computing device 108 can determine the reference distribution 704 by calculating (i) the distances between the primary events and the secondary events in the reference group, and (ii) the number of times such distances occur in the reference group.

In some examples, the computing device 108 can additionally or alternatively determine the reference distribution 704 based on angles (e.g., azimuth angles) between the primary events and the secondary events in the reference group. In one such example, the X-axis of FIG. 7 can indicate angles between primary events and secondary events in a particular group. The Y-axis can indicate the number of times at which primary events and secondary events are at a certain angle from one another in the particular group. The computing device 108 can determine the reference distribution 704 by calculating (i) the angles between the primary events and the secondary events in the reference group, and (ii) the number of times such angles occur in the reference group. The computing device 108 can use any number and combination of parameters (e.g., distance, angle, etc.) to determine the reference distribution 704.

In block 418, the computing device 108 determines if an end criterion is satisfied. In some examples, the end criterion can be an iteration threshold. For example, a user may wish to generate a particular number of estimated distributions of microseismic events. And each time some or all of the steps of blocks 418-430 are performed, the computing device 108 may generate a new or different estimated distribution of microseismic events. In such an example, the end criterion can be the particular number of estimated distributions to generate. The computing device 108 can iterate some or all of the steps of blocks 418-430, generating a new estimated-distribution in each iteration, until the desired number of estimated distributions have been generated.

In some examples, computing device 108 can receive the end criterion as user input. For example, a well operator can provide the end to the computing device 108 using a keyboard.

If the computing device 108 determines that the end criterion is satisfied, the process can proceed to block 430. Otherwise, the process can proceed to block 420.

In block 420, the computing device 108 determines a next distribution (e.g., another distribution) for a next group (e.g., another group that is distinct from the reference group). The next group can be the next-closest group to the observation well. The computing device 108 can determine the next distribution using one or more of the methods described with respect to block 416.

As a particular example, referring to FIG. 7, the next distribution can be distribution 706 associated with Group 2 (e.g., which can be the next-closest group to the observation well after Group 1, as shown in FIG. 6). The distribution 706 indicates that there is, on average, one secondary event within 25 feet of a primary event, four secondary events between 40 and 45 feet of a primary event, seven secondary events between 65 and 70 feet from a primary event, etc. The computing device 108 can generate the distribution 706 by calculating (i) the distances between the primary events and the secondary events in Group 2, and (ii) the number of times such distances occur in Group 2.

In block 422, the computing device 108 determines if the next distribution matches the reference distribution. For example, the computing device 108 can determine if the number and arrangement of primary events and secondary events in the next distribution matches the number and arrangement of primary events and secondary events in the reference distribution. If so, the computing device 108 can determine that the next distribution matches the reference distribution. Otherwise, the computing device 108 can determine that the next distribution does not match the reference distribution.

As a particular example, referring to FIG. 7, the reference distribution 704 indicates that there is one secondary event within 20 feet of a primary event, six secondary events between 40 and 45 feet of a primary event, and 11 secondary events between 65 and 70 feet from a primary event. The distribution 706 indicates that there is one secondary event within 25 feet of a primary event, four secondary events between 40 and 45 feet of a primary event, and seven secondary events between 65 and 70 feet from a primary event. Thus, there are differences between the reference distribution 704 and the distribution 706.

In some examples, the computing device 108 can determine if the next distribution matches the reference distribution to within a predetermined tolerance. For example, the computing device 108 can determine if the number of differences between the next distribution and the reference distribution is below a threshold number of differences (e.g., 10 differences). If so, the computing device 108 can determine that the next distribution matches the reference distribution. Otherwise, the computing device 108 can determine that the next distribution does not match the reference distribution.

In some examples, the distribution of microseismic events along a fracture may not be uniform. Different distributions of microseismic events can occur along the fracture depending on the geological characteristics of the subterranean formation being fractured. The computing device 108 can account for this variability by scaling the reference distribution or otherwise modifying the reference distribution in a way that is appropriate for the spatial position of the next group along the fracture. The computing device 108 can then use the modified reference-distribution as the reference distribution (e.g., the computing device can determine if the next distribution matches the modified reference-distribution, rather than the original reference-distribution).

If the computing device 108 determines that the next distribution does not match the reference distribution, the process can proceed to block 424. Otherwise, the process can proceed to block 428.

In block 424, the computing device 108 selects (e.g., at random) a primary event in the next group and determines if the distribution of secondary events around the primary event matches the reference distribution (e.g., matches an average distribution of the reference distribution as a whole). If so, the computing device 108 iterates this step, selecting a next primary-event and determining if the next primary event matches the reference distribution. The computing device 108 can select the next primary-event randomly or can select a nearest neighbor to the previous primary-event for use as the next primary-event. The computing device 108 can iterate this step until the computing device 108 identifies a primary event that has a distribution of secondary events that is different from the reference distribution. If the computing device 108 determines that the distribution of secondary events around the primary event is different from the reference distribution, the process can proceed to block 426.

In block 426, the computing device 108 adds a new secondary event around the primary event to bring the next distribution more into conformity with the reference distribution. For example, it can be assumed that the difference between the distribution of secondary events around the primary event and the reference distribution is due to secondary events around the primary event being inadequately detected. The computing device 108 can counteract this inadequate detection by adding in one or more secondary events around the primary event. For example, the computing device 108 can populate the area around the primary event with one or more new secondary-events to bring the next distribution more into conformity with the reference distribution. More particularly, in some examples, the computing device 108 can generate (e.g., simulate or synthesize) a new (e.g., pseudo) secondary-event at a particular distance, angle, or both around the primary event to bring the next distribution more into conformity with the reference distribution.

As a particular example, the computing device 108 can determine that the next distribution lacks a secondary event in a particular distance, angle, or both from a primary event by comparing the reference distribution to the distribution of secondary events around the primary event. In response, the computing device 108 can generate a new secondary-event at the particular distance, angle, or both from a primary event. As another example, the computing device 108 can populate the area around the primary event by stochastically generating new secondary events in appropriate distance and angle ranges around the primary event.

In some examples, the computing device 108 can determine other characteristics for a new secondary event additionally or alternatively to the location of the new secondary event. For example, the computing device 108 can determine a travel time or an arrival time for an elastic wave associated with the new secondary event. The travel time can be the duration for which an elastic wave traveled through a subterranean formation. The arrival time can be the time at which the elastic wave arrived at a sensor or an observation well. As a particular example, the computing device 108 can use an algorithm to determine a travel time for an elastic wave in a simple medium (e.g., a homogenous, isotropic medium). The computing device 108 can determine the arrival time of the elastic wave based on the travel time. The computing device 108 can assign the travel time, arrival time, or both of these to a new secondary event. As another example, the computing device 108 can simulate propagation of an elastic wave through a more complex medium. The computing device 108 can determine the travel time, the arrival time, or both of these based on the simulated propagation of the elastic wave. The computing device 108 can assign the travel time, arrival time, or both of these to a new secondary event. Additionally or alternatively, the computing device 108 can determine the magnitude of the elastic wave associated with a new secondary event. For example, the computing device 108 can determine the magnitude based on an amplitude of a compressional wave in a particular frequency band. As another example, the computing device 108 can determine the magnitude based on a seismic moment (e.g., derived from a moment tensor). These additional characteristics may be useful if, for example, a well operator wishes to analyze the moment density of the microseismic events, rather than a spatial density of the microseismic events.

In some examples, the computing device 108 can use geostatistical techniques or other statistical techniques to generate a new secondary event or characteristics of the new secondary event. In one example, the computing device 108 can generate a new secondary event based on the assumption that events are more likely to occur along, rather than perpendicular to, a fracture strike relative to a primary event.

After block 426, the process can return to block 422, where the computing device 108 can compare an updated version of the next distribution to the reference distribution. For example, the computing device 422 can compare the updated distribution for the whole of the next group to the reference distribution. If the computing device 108 determines that the updated version of the next distribution does not match the reference distribution, the process can again proceed to block 424. In some examples, the steps shown in blocks 422-426 can repeat until the computing device 108 determines that the next distribution (e.g., an updated version of the next distribution) matches the reference distribution.

In block 428, the computing device 108 determines if all of the groups (e.g., generated in block 412) have been analyzed. If not, the process can proceed to block 420, where the computing device 108 determines another distribution for another group. In some examples, the steps of blocks 420-428 can be iterated until distributions for all of the groups (e.g., distributions 704-710 of FIG. 7) have been generated, compared to the reference distribution, and corrected as needed.

If the computing device 108 determines that all of the groups have been analyzed, the process can return to block 418, where the computing device 108 can again check whether the end criterion has been satisfied. If the computing device 108 determines that the end criterion has been satisfied, the process can proceed to block 430. Otherwise, the computing device 108 can store the results (e.g., a corrected distribution for the groups) from the previous iteration of blocks 420-428. The computing device 108 can then iterate the steps of blocks 420-428 again to obtain another set of results. In some examples, the results from the iterations can deviate from one another due to the different orders in which the primary events were selected during the correction process (e.g., in block 424), and the differences in how new secondary events are generated around each primary event in block 426.

In block 430, the computing device 108 can analyze the results, output the results, or both of these. For example, the computing device 108 can analyze the results (e.g., from two or more of the iterations of blocks 420-428) to determine an average number of microseismic events in each group. The computing device 108 can display information (e.g., a graph) indicating the average number of microseismic events in each group. As another example, the computing device 108 can analyze the results to determine an average density of microseismic events in each group. The computing device 108 can display information indicating the average density of microseismic events in each group. As still another example, the computing device 108 can aggregate the results and display information indicating the aggregated results.

In some examples, the user can customize how the results are to be aggregated, analyzed, displayed, or any combination of these. For example, the computing device 108 can receive user input indicating how results are to be analyzed, aggregated, or combined. The computing device 108 can then analyze, aggregate, or combine the results in accordance with the user input.

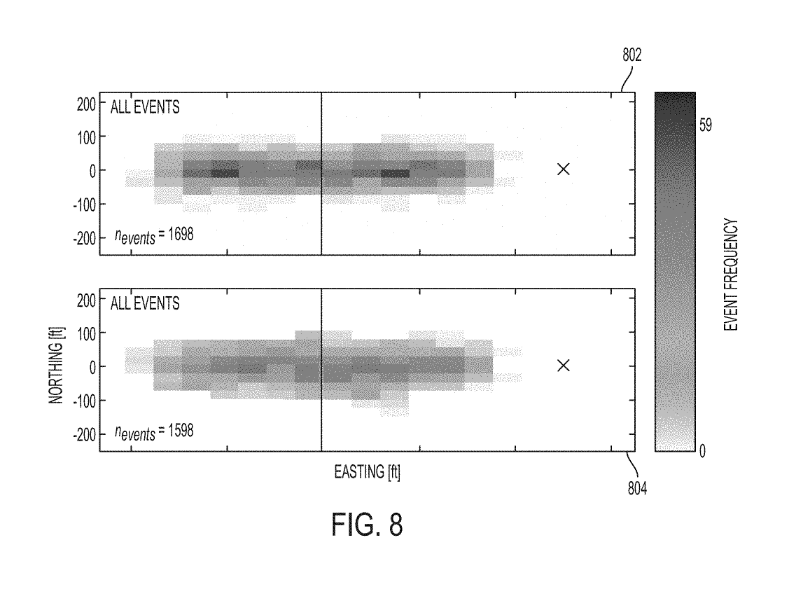

An example of results from the process of FIG. 4 is shown in FIG. 8. Graph 802 can represent an ideal, known spatial distribution of microseismic events generated using a synthetic data set that had a total of 1,698 microseismic events. And graph 804 can represent a spatial distribution of microseismic events generated via the process shown in FIG. 4. As shown, the spatial distribution of microseismic events in graph 804 is similar to the spatial distribution of microseismic events shown in graph 802. And the process of FIG. 4 yielded a similar number of microseismic events—1,598 microseismic events—to the total number of microseismic events in the synthetic data set. Thus, the graph 802 is an accurate approximation of the spatial distribution of the microseismic events in the synthetic data set.

Although FIG. 8 shows results generated using synthetic data, the process of FIG. 4 can be applied to actual microseismic-event data associated with real microseismic events occurring in a subterranean formation (and detected by sensors), for which there may not be a known spatial distribution. To determine the spatial distribution of microseismic events, the computing device 108 can implement the process of FIG. 4 and graph the results (e.g., similarly to graph 804).

In some aspects, biases in microseismic-event data can be corrected according to one or more of the following examples:

### Example #1

A method can include generating a first distribution that is representative of a distribution of microseismic events that occurred in a first area of a subterranean formation. The method can include generating a second distribution that is representative of another distribution of microseismic events that occurred in a second area of the subterranean formation that is farther from an observation well than the first area. The method can include correcting the second distribution by including in the second distribution microseismic events that have characteristics for reducing a difference between the first distribution and the second distribution.

### Example #2

The method of Example #1 may feature generating the first distribution by determining a plurality of distances between primary events and secondary events that occurred within the first area of the subterranean formation. A primary event can be a microseismic event for which a characteristic satisfies a condition. A secondary event can be another microseismic event for which the characteristic does not satisfy the condition. The characteristic can be a magnitude and the condition can include exceeding a magnitude threshold. The method may feature determining how many times each distance is present in the plurality of distances.

### Example #3

The method of any of Examples #1-2 may include generating the second distribution by determining a plurality of distances between primary events and secondary events that occurred within the second area of the subterranean formation. The method can include determining how many times each distance is present in the plurality of distances.

### Example #4

The method of any of Examples #1-3 may feature receiving, from a sensor positioned in a wellbore, sensor signals associated with microseismic events that occurred in the subterranean formation. The method may feature determining microseismic-event data based on the sensor signals. The method may feature, for each microseismic event in the microseismic-event data: determining that the microseismic event is a primary event based on the characteristic for the microseismic event satisfying a condition; or determining that the microseismic event is a secondary event based on the characteristic for the microseismic event not satisfying the condition.

### Example #5

The method of any of Examples #1-4 can include categorizing microseismic events in microseismic-event data into a plurality of groups based on respective distances of the microseismic events to an observation well. The method can include selecting a particular group of the plurality of groups for use as a reference group based on the particular group having microseismic events that are closer to the observation well than a remainder of the groups in the plurality of groups. The method can include determining the first distribution using the microseismic events in the reference group.

### Example #6

The method of Example #5 can include analyzing each group of the remainder of the groups. The method can include generating a respective distribution of the respective microseismic events in a respective group. The method can include comparing the respective distribution to the first distribution to determine if there is an inconsistency between the respective distribution and the first distribution. The method can include, based on determining that there is the inconsistency between the respective distribution and the first distribution: generating a corrected version of the respective group by including in the respective group one or more microseismic events having characteristics for reducing the inconsistency between the respective distribution and the first distribution; and generating a corrected version of the respective distribution using the corrected version of the respective group.

### Example #7

The method of Example #6 can include determining that all of the groups on the remainder of the groups have been analyzed. The method can include, based on determining that all of the groups in the remainder of the groups have been analyzed, determining that an end criterion has been satisfied. The method can include, based on determining that the end criterion has been satisfied: determining an estimated distribution of microseismic events that occurred in the subterranean formation by combining information from a plurality of corrected versions of respective distributions; and displaying a graph indicating the estimated distribution of microseismic events.

### Example #8

A system can include a sensor positionable proximate to a subterranean formation for detecting microseismic events in the subterranean formation and transmitting sensor signals associated with the microseismic events. The system can include a computing device communicatively coupled to the sensor. The computing device can generate, based on the sensor signals, a first distribution that is representative of a distribution of microseismic events that occurred in a first area of the subterranean formation. The computing device can generate, based on the sensor signals, a second distribution that is representative of another distribution of microseismic events that occurred in a second area of the subterranean formation that is farther from the sensor than the first area. The computing device can generate a corrected version of the second distribution by including in the second distribution microseismic events that have characteristics for reducing a difference between the first distribution and the second distribution. The computing device can display the corrected version of the second distribution via a display device.

### Example #9

The system of Example #8 may feature the sensor including a geophone. The system may feature the computing device including a processing device and a memory device on which instructions executable by the processing device are stored. The instructions can cause the processing device to generate the first distribution. The instructions can cause the processing device to determine a plurality of distances between primary events and secondary events that occurred within the first area of the subterranean formation. A primary event can be a microseismic event for which a characteristic satisfies a condition. A secondary event can be another microseismic event for which the characteristic does not satisfy the condition. The characteristic can be a magnitude and the condition can include exceeding a magnitude threshold. The instructions can cause the processing device to determine how many times each distance is present in the plurality of distances.

### Example #10

The system of any of Examples #8-9 may feature the memory device further including instructions that are executable by the processing device for causing the processing device to generate the second distribution. The instructions can cause the processing device to determine a plurality of distances between primary events and secondary events that occurred within the second area of the subterranean formation. The instructions can cause the processing device to determine how many times each distance is present in the plurality of distances.

### Example #11

The system of any of Examples #8-10 may feature the memory device further including instructions that are executable by the processing device for causing the processing device to determine microseismic-event data based on the sensor signals. The instructions can cause the processing device to, for each microseismic event in the microseismic-event data: determine that the microseismic event is a primary event based on the characteristic for the microseismic event satisfying a condition; or determine that the microseismic event is a secondary event based on the characteristic for the microseismic event not satisfying the condition.

### Example #12

The system of any of Examples #8-11 may feature the memory device further including instructions that are executable by the processing device for causing the processing device to categorize microseismic events in microseismic-event data into a plurality of groups based on respective distances of the microseismic events to the sensor. The instructions can cause the processing device to select a particular group of the plurality of groups for use as a reference group based on the particular group having microseismic events that are closer to the sensor than a remainder of the groups in the plurality of groups. The instructions can cause the processing device to determine the first distribution using the microseismic events in the reference group.

### Example #13

The system of Example #12 may feature the memory device further including instructions that are executable by the processing device for causing the processing device to analyze each group of the remainder of the groups. The instructions can cause the processing device to generate a respective distribution of the respective microseismic events in a respective group. The instructions can cause the processing device to compare the respective distribution to the first distribution to determine if there is an inconsistency between the respective distribution and the first distribution. The instructions can cause the processing device to, based on determining that there is the inconsistency between the respective distribution and the first distribution: generate a corrected version of the respective group by including in the respective group one or more microseismic events having characteristics for reducing the inconsistency between the respective distribution and the first distribution; and generate a corrected version of the respective distribution using the corrected version of the respective group.

### Example #14

The system of Example #13 may feature the memory device further including instructions that are executable by the processing device for causing the processing device to determine whether all of the groups on the remainder of the groups have been analyzed. The instructions can cause the processing device to, based on determining that all of the groups in the remainder of the groups have been analyzed, determine whether an end criterion has been satisfied. The instructions can cause the processing device to, based on determining that the end criterion has been satisfied: determine an estimated distribution of microseismic events that occurred in the subterranean formation by combining information from a plurality of corrected versions of respective models; and display, on the display device, a graph indicating the estimated distribution of microseismic events.

### Example #15

A non-transitory computer-readable medium can include instructions that are executable by a processing device for causing the processing device to generate a first distribution that is representative of a distribution of microseismic events that occurred in a first area of a subterranean formation. The instructions can cause the processing device to generate a second distribution that is representative of another distribution of microseismic events that occurred in a second area of the subterranean formation that is farther from an observation well than the first area. The instructions can cause the processing device to correct the second distribution by including in the second distribution microseismic events that have characteristics for reducing a difference between the first distribution and the second distribution.

### Example #16

The non-transitory computer-readable medium of Example #15 may further include instructions that are executable by the processing device for causing the processing device to generate the first distribution. The instructions can cause the processing device to determine a plurality of distances between primary events and secondary events that occurred within the first area of the subterranean formation. A primary event can be a microseismic event for which a characteristic satisfies a condition. A secondary event can be another microseismic event for which the characteristic does not satisfy the condition. The characteristic can be a magnitude and the condition can include exceeding a magnitude threshold. The instructions can cause the processing device to determine how many times each distance is present in the plurality of distances.

### Example #17

The non-transitory computer-readable medium of any of Examples #15-16 may further include instructions that are executable by the processing device for causing the processing device to generate the second distribution. The instructions can cause the processing device to determine a plurality of distances between primary events and secondary events that occurred within the second area of the subterranean formation. The instructions can cause the processing device to determine how many times each distance is present in the plurality of distances.

### Example #18

The non-transitory computer-readable medium of any of Examples #15-17 may further include instructions that are executable by the processing device for causing the processing device to receive, from a sensor positioned in a wellbore, sensor signals associated with microseismic events that occurred in the subterranean formation. The instructions can cause the processing device determine microseismic-event data based on the sensor signals. The instructions can cause the processing device to, for each microseismic event in the microseismic-event data: determine that the microseismic event is a primary event based on the characteristic for the microseismic event satisfying a condition; or determine that the microseismic event is a secondary event based on the characteristic for the microseismic event not satisfying the condition.

### Example #19

The non-transitory computer-readable medium of any of Examples #15-18 may further include instructions that are executable by the processing device for causing the processing device to categorize microseismic events in microseismic-event data into a plurality of groups based on respective distances of the microseismic events to the observation well. The instructions can cause the processing device to select a particular group of the plurality of groups for use as a reference group based on the particular group having microseismic events that are closer to the sensor than a remainder of the groups in the plurality of groups. The instructions can cause the processing device to determine the first distribution using the microseismic events in the reference group.

### Example #20

The non-transitory computer-readable medium of Example #19 may further include instructions that are executable by the processing device for causing the processing device to analyze each group of the remainder of the groups. The instructions can cause the processing device to generate a respective distribution of the respective microseismic events in a respective group. The instructions can cause the processing device to compare the respective distribution to the first distribution to determine if there is an inconsistency between the respective distribution and the first distribution. The instructions can cause the processing device to, based on determining that there is the inconsistency between the respective distribution and the first distribution: generate a corrected version of the respective group by including in the respective group one or more microseismic events having characteristics for reducing the inconsistency between the respective distribution and the first distribution; and generate a corrected version of the respective distribution using the corrected version of the respective group.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

1. A method comprising:
generating, by a processing device, a first distribution that is representative of a distribution of microseismic events that occurred in a first area of a subterranean formation;
generating, by the processing device, a second distribution that is representative of another distribution of microseismic events that occurred in a second area of the subterranean formation that is farther from an observation well than the first area; and
correcting, by the processing device, the second distribution by including in the second distribution microseismic events that have characteristics for reducing a difference between the first distribution and the second distribution.

2. The method of claim 1, further comprising generating the first distribution by:
determining a plurality of distances between primary events and secondary events that occurred within the first area of the subterranean formation, a primary event being a microseismic event for which a characteristic satisfies a condition and a secondary event being another microseismic event for which the characteristic does not satisfy the condition; and
determining how many times each distance is present in the plurality of distances.

3. The method of claim 2, wherein the characteristic is a magnitude and the condition includes exceeding a magnitude threshold, the method further comprising generating the second distribution by:
determining another plurality of distances between primary events and secondary events that occurred within the second area of the subterranean formation; and
determining how many times each distance is present in the other plurality of distances.

4. The method of claim 3, further comprising:
receiving, from a sensor positioned in a wellbore, sensor signals associated with microseismic events that occurred in the subterranean formation;
determining microseismic-event data based on the sensor signals; and
for each microseismic event in the microseismic-event data:
determining that the microseismic event is the primary event based on the characteristic for the microseismic event satisfying the condition; or
determining that the microseismic event is the secondary event based on the characteristic for the microseismic event not satisfying the condition.

5. The method of claim 4, further comprising:
categorizing the microseismic events in the microseismic-event data into a plurality of groups based on respective distances of the microseismic events to the observation well;
selecting a particular group of the plurality of groups for use as a reference group based on the particular group having microseismic events that are closer to the observation well than a remainder of the groups in the plurality of groups; and
determining the first distribution using the microseismic events in the reference group.

6. The method of claim 5, further comprising, analyzing each group of the remainder of the groups by:
generating a respective distribution of the respective microseismic events in a respective group;
comparing the respective distribution to the first distribution to determine if there is an inconsistency between the respective distribution and the first distribution; and
based on determining that there is the inconsistency between the respective distribution and the first distribution:
generating a corrected version of the respective group by including in the respective group one or more microseismic events having characteristics for reducing the inconsistency between the respective distribution and the first distribution; and
generating a corrected version of the respective distribution using the corrected version of the respective group.

7. The method of claim 6, further comprising:
determining that all of the groups on the remainder of the groups have been analyzed;
based on determining that all of the groups in the remainder of the groups have been analyzed, determining that an end criterion has been satisfied; and
based on determining that the end criterion has been satisfied:
determining an estimated distribution of microseismic events that occurred in the subterranean formation by combining information from a plurality of corrected versions of respective distributions; and
displaying a graph indicating the estimated distribution of microseismic events.

8. A system comprising:
a sensor positionable proximate to a subterranean formation for detecting microseismic events in the subterranean formation and transmitting sensor signals associated with the microseismic events; and
a computing device communicatively coupled to the sensor for:
generating, based on the sensor signals, a first distribution that is representative of a distribution of microseismic events that occurred in a first area of the subterranean formation;
generating, based on the sensor signals, a second distribution that is representative of another distribution of microseismic events that occurred in a second area of the subterranean formation that is farther from the sensor than the first area;
generating a corrected version of the second distribution by including in the second distribution microseismic events that have characteristics for reducing a difference between the first distribution and the second distribution; and
displaying the corrected version of the second distribution via a display device.

9. The system of claim 8, wherein the sensor comprises a geophone and the computing device comprises:
a processing device; and
a memory device on which instructions executable by the processing device are stored for causing the processing device to generate the first distribution by:
determining a plurality of distances between primary events and secondary events that occurred within the first area of the subterranean formation, a primary event being a microseismic event for which a characteristic satisfies a condition and a secondary event being another microseismic event for which the characteristic does not satisfy the condition; and
determining how many times each distance is present in the plurality of distances.

10. The system of claim 9, wherein the characteristic is a magnitude, the condition includes exceeding a magnitude threshold, and the memory device further comprises instructions that are executable by the processing device for causing the processing device to generate the second distribution by:
determining another plurality of distances between primary events and secondary events that occurred within the second area of the subterranean formation; and
determining how many times each distance is present in the other plurality of distances.

11. The system of claim 10, wherein the memory device further comprises instructions that are executable by the processing device for causing the processing device to:
determine microseismic-event data based on the sensor signals; and
for each microseismic event in the microseismic-event data:
determine that the microseismic event is the primary event based on the characteristic for the microseismic event satisfying the condition; or
determine that the microseismic event is the secondary event based on the characteristic for the microseismic event not satisfying the condition.

12. The system of claim 11, wherein the memory device further comprises instructions that are executable by the processing device for causing the processing device to:
categorize the microseismic events in the microseismic-event data into a plurality of groups based on respective distances of the microseismic events to the sensor;
select a particular group of the plurality of groups for use as a reference group based on the particular group having microseismic events that are closer to the sensor than a remainder of the groups in the plurality of groups; and
determine the first distribution using the microseismic events in the reference group.

13. The system of claim 12, wherein the memory device further comprises instructions that are executable by the processing device for causing the processing device to analyze each group of the remainder of the groups by:
generating a respective distribution of the respective microseismic events in a respective group;
comparing the respective distribution to the first distribution to determine if there is an inconsistency between the respective distribution and the first distribution; and
based on determining that there is the inconsistency between the respective distribution and the first distribution:
generating a corrected version of the respective group by including in the respective group one or more microseismic events having characteristics for reducing the inconsistency between the respective distribution and the first distribution; and
generating a corrected version of the respective distribution using the corrected version of the respective group.

14. The system of claim 13, wherein the memory device further comprises instructions that are executable by the processing device for causing the processing device to:
determine whether all of the groups on the remainder of the groups have been analyzed;
based on determining that all of the groups in the remainder of the groups have been analyzed, determine whether an end criterion has been satisfied;
based on determining that the end criterion has been satisfied:
determine an estimated distribution of microseismic events that occurred in the subterranean formation by combining information from a plurality of corrected versions of respective models; and
display, on the display device, a graph indicating the estimated distribution of microseismic events.

15. A non-transitory computer-readable medium that includes instructions that are executable by a processing device for causing the processing device to:
generate a first distribution that is representative of a distribution of microseismic events that occurred in a first area of a subterranean formation;
generate a second distribution that is representative of another distribution of microseismic events that occurred in a second area of the subterranean formation that is farther from an observation well than the first area; and
correct the second distribution by including in the second distribution microseismic events that have characteristics for reducing a difference between the first distribution and the second distribution.

16. The non-transitory computer-readable medium of claim 15, further comprising instructions that are executable by the processing device for causing the processing device to generate the first distribution by:
determining a plurality of distances between primary events and secondary events that occurred within the first area of the subterranean formation, a primary event being a microseismic event for which a characteristic satisfies a condition and a secondary event being another microseismic event for which the characteristic does not satisfy the condition; and
determining how many times each distance is present in the plurality of distances.

17. The non-transitory computer-readable medium of claim 16, wherein the characteristic is a magnitude, the criterion includes exceeding a magnitude threshold, and further comprising instructions that are executable by the processing device for causing the processing device to generate the second distribution by:
determining another plurality of distances between primary events and secondary events that occurred within the second area of the subterranean formation; and
determining how many times each distance is present in the other plurality of distances.

18. The non-transitory computer-readable medium of claim 17, further comprising instructions that are executable by the processing device for causing the processing device to:
receive, from a sensor positioned in a wellbore, sensor signals associated with microseismic events that occurred in the subterranean formation;
determine microseismic-event data based on the sensor signals; and
for each microseismic event in the microseismic-event data:
determine that the microseismic event is the primary event based on the characteristic for the microseismic event satisfying the condition; or
determine that the microseismic event is the secondary event based on the characteristic for the microseismic event not satisfying the condition.

19. The non-transitory computer-readable medium of claim 18, further comprising instructions that are executable by the processing device for causing the processing device to:
categorize the microseismic events in the microseismic-event data into a plurality of groups based on respective distances of the microseismic events to the observation well;
select a particular group of the plurality of groups for use as a reference group based on the particular group having microseismic events that are closer to the observation well than a remainder of the groups in the plurality of groups; and
determine the first distribution using the microseismic events in the reference group.

20. The non-transitory computer-readable medium of claim 19, further comprising instructions that are executable by the processing device for causing the processing device to analyze each group of the remainder of the groups by:
generating a respective distribution based on the respective microseismic events in a respective group;
comparing the respective distribution to the first distribution to determine if there is an inconsistency between the respective distribution and the first distribution; and
based on determining that there is the inconsistency between the respective distribution and the first distribution:
generating a corrected version of the respective group by including in the respective group one or more microseismic events having characteristics for reducing the inconsistency between the respective distribution and the first distribution; and
generating a corrected version of the respective distribution using the corrected version of the respective group.

21-35. (canceled)
